(19) United States
(12) Patent Application Publication
(10) Pub. No.: US 2016/0167166 A1
(43) Pub. Date: Jun. 16, 2016

(54) LASER PROCESSING METHOD AND LASER BEAM IRRADIATION APPARATUS

(71) Applicant: SUMITOMO Electric Industries ,Ltd., Osaka-shi (JP)

(72) Inventors: Shigehiro NAGANO, Yokohama-shi (JP); Motoki KAKUI, Yokohama-shi (JP); Yasuhiro OKAMOTO, Okayama-shi (JP); Akira OKADA, Okayama-shi (JP)

(21) Appl. No.: 14/436,616

(22) PCT Filed: Oct. 1, 2013
(86) PCT No.: PCT/JP2013/076636

§ 371 Date: Apr. 17, 2015

(30) Foreign Application Priority Data
Oct. 18, 2012 (JP) 2012-230968

(51) Int. Cl. B23K 26/06; B23K 26/046

(52) U.S. Cl. CPC B23K 26/0648; B23K 26/046

(57) ABSTRACT

There is provided a laser processing method using a laser processing apparatus including a laser beam source for outputting a laser beam including a plurality of wavelength components, a collimating lens for receiving the laser beam, and a focusing lens for receiving the laser beam collimated by the collimating lens, the laser processing method including the step of: irradiating a material to be processed with the laser beam focused by the focusing lens in the laser processing apparatus. In the step of irradiating the material to be processed with the laser beam, positions of the collimating lens and the focusing lens are adjusted, and a wavefront shape of the laser beam received by the focusing lens is adjusted, thereby adjusting a size of a focusing area constituted by a plurality of focuses corresponding to the plurality of wavelength components of the laser beam focused by the focusing lens.

### TECHNICAL FIELD

The present invention relates to a laser processing method and a laser beam irradiation apparatus, and more particularly to a laser processing method and a laser beam irradiation apparatus used for cutting and cleaving or division processing of a material to be processed.

### BACKGROUND ART

A laser processing method using a laser beam to cut and cleave a material to be processed has been conventionally known. For example, Japanese Patent Laying-Open No. 2010-158686 (PTD 1) discloses that a multi-wavelength coherent beam is focused and a plurality of focusing points are formed at different positions on an optical axis, thereby forming a long modified layer in a material to be processed by single laser irradiation. According to Japanese Patent Laying-Open No. 2010-158686, a chromatic aberration lens or a chromatic aberration lens unit is used in a focusing system of a laser processing apparatus. A collimating lens for collimating a laser beam is arranged at a stage preceding the chromatic aberration lens, and a chromatic aberration-free lens is used as the collimating lens.

### CITATION LIST

### Patent Document

### PTD 1: Japanese Patent Laying-Open No. 2010-158686

### SUMMARY OF INVENTION

### Technical Problem

In the aforementioned conventional laser processing method, a position of each of the plurality of focusing points arranged on the optical axis (a distance from a focusing lens or a focal length) is determined by a wavelength of the laser beam and a chromatic aberration property of the focusing lens. Therefore, in order to adjust the position of the focusing point (adjust the focal length), there was no choice but to select the property of the focusing lens and/or the wavelength of the laser beam. Therefore, it was difficult to arbitrarily adjust a distribution range of the focusing points (e.g., a length of a distribution area of the focusing points on the optical axis) depending on, for example, the size of the material to be processed and the like.

The present invention has been made to solve the above problems and an object of the present invention is to provide a laser processing method and a laser beam irradiation apparatus in which a distribution range of focusing points of a laser beam can be easily adjusted.

### Solution to Problem

A laser processing method according to the present invention is a laser processing method using a laser processing apparatus including a laser beam source for outputting a laser beam including a plurality of wavelength components, a collimating lens for receiving the laser beam emitted from the laser beam source, a focusing lens for receiving the laser beam collimated by the collimating lens, a collimating lens position adjusting unit for adjusting a position of the collimating lens with respect to the laser beam source, and a focusing lens position adjusting unit for adjusting a position of the focusing lens with respect to the collimating lens, the laser processing method including the steps of: preparing a material to be processed; and irradiating the material to be processed with the laser beam focused by the focusing lens in the laser processing apparatus. In the step of irradiating the material to be processed with the laser beam, positions of the collimating lens and the focusing lens are adjusted by the collimating lens position adjusting unit and the focusing lens position adjusting unit, and a wavefront shape of the laser beam received by the focusing lens is adjusted, thereby adjusting a size of a focusing area constituted by a plurality of focuses corresponding to the plurality of wavelength components of the laser beam focused by the focusing lens.

With such a configuration, the wavefront shape of the laser beam received by the focusing lens is adjusted, and thus, chromatic aberration in the focusing lens can be increased or decreased as compared with the case in which the laser beam received by the focusing lens is a planar wave. As a result, the size of the focusing area of the laser beam can be adjusted over a wider range, as compared with the case in which the size of the focusing area is adjusted based only on the property of the focusing lens and the wavelength of the laser beam. In addition, as described above, the size of the focusing area can be adjusted by adjusting the positions of the collimating lens and the focusing lens. Therefore, replacement of the lens itself, change of the wavelength of the laser beam, and the like are not required, and the size of the focusing area can be easily adjusted. Thus, the length of the focusing area can be easily adjusted in accordance with a thickness of a processed area of the material to be processed a thickness in the direction along the optical axis direction).

A laser beam irradiation apparatus according to the present invention is a laser beam irradiation apparatus that irradiates a material to be processed with a laser beam having a continuous spectrum with a prescribed wavelength width and including wavelength components within a wavelength range of 1.0 μm to 1.3 μm. The laser beam irradiation apparatus includes: an input port for taking in the laser beam from a laser beam source; a collimating lens for collimating the laser beam from the input port; and a focusing lens for focusing the laser beam from the collimating lens. The collimating lens is placed in a collimating lens placement unit and a placement position of the collimating lens with respect to the input port is adjusted by a collimating position adjusting unit. A wavefront of each wavelength component of the laser beam is set to be constant at the input port. When a reference position is a focal length of a center wavelength component of the collimating lens, an interval between the input port and the collimating lens is adjusted such that the collimating lens is located on the focusing lens side with respect to the reference position within a range of 100 μm to 850 μm, and an interval between the collimating lens and the focusing lens is adjusted within a range of 10 mm to 500 mm.

### Advantageous Effects of Invention

According to the present invention, the size of the focusing area of the laser beam can be easily adjusted over a wider range than conventional, depending on the thickness of the processed area of the material to be processed.

### BRIEF DESCRIPTION OF DRAWINGS

FIG. 1 is a schematic view for describing a laser processing method.

FIG. 2 is a schematic view for describing chromatic aberration in a focusing lens.

FIG. 3 is a graph showing a relationship between a wavelength of a laser beam and chromatic aberration in the focusing lens.

FIG. 4 is a flowchart for describing the laser processing method according to the present invention.

FIG. 5 is a schematic view for describing an optical system used in the laser processing method according to the present invention.

FIG. 6 is a schematic view for describing the optical system used in the laser processing method according to the present invention.

FIG. 7 is a schematic view for describing a relationship between a wavefront shape of a laser beam and chromatic aberration.

FIG. 8 is a schematic view for describing a relationship between a wavefront shape of a laser beam and chromatic aberration.

FIG. 9 is a schematic view for describing a method for controlling a wavefront shape of a laser beam received by the focusing lens.

FIG. 10 is a graph showing a relationship between a wavelength of a laser beam and chromatic aberration in the focusing lens.

FIG. 11 is a graph showing a relationship between a wavelength of a laser beam and chromatic aberration in the focusing lens.

FIG. 12 is a graph showing a relationship between a wavelength of a laser beam and a beam spot diameter in the focusing lens.

FIG. 13 is a graph showing a relationship between a wavelength of a laser beam and a beam spot diameter in the focusing lens.

FIG. 14 is a graph showing a relationship between an interval between a collimating lens and the focusing lens and chromatic aberration.

FIG. 15 is a graph showing a relationship between an interval between the collimating lens and the focusing lens and a beam spot diameter having a maximum value among the investigated laser beam wavelengths.

FIG. 16 is a graph showing a relationship between an interval between the collimating lens and the focusing lens and WD (working distance).

FIG. 17 is a graph showing a relationship between an interval between the collimating lens and the focusing lens and chromatic aberration.

FIG. 18 is a graph showing a relationship between an interval between the collimating lens and the focusing lens and abeam spot diameter having a maximum value among the investigated laser beam wavelengths.

FIG. 19 is a graph showing a relationship between an interval between the collimating lens and the focusing lens and WD (working distance).

### DESCRIPTION OF EMBODIMENTS

An embodiment of the present invention will be described hereinafter with reference to the drawings, in which the same reference numerals are allotted to the same or corresponding portions and description thereof will not be repeated.

In a laser processing method according to the present invention, a laser beam including a plurality of wavelength components is focused by a focusing lens, thereby forming a linear focusing line (a focusing area), and a modified layer is formed in a material to be processed based on this focusing area. In order to facilitate understanding of the present invention, studies conducted by the inventors before the completion of the present invention will be described hereinafter, and an embodiment of the present invention will also be described hereinafter.

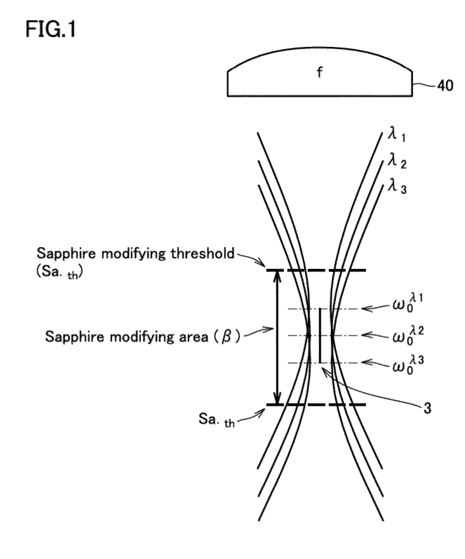

When a laser beam having a wide wavelength band (e.g., a wavelength band of 1060 nm to 1300 nm) passes through the focusing lens, chromatic aberration occurs. As a result, focuses of the respective wavelength components are linearly arranged along an optical axis direction. By positioning the focusing line inside the material to be processed, the modified layer is formed in the material to be processed along the focusing line. As shown in FIG. 1, the focuses of the respective wavelength components of the laser beam are linearly arranged along the optical axis direction and form the focusing line. The respective wavelength components having wavelengths λ₁, λ₂ and λ₃ are focused at beam spots (ω^{λ1}₀, ω^{λ2}₀, ω^{λ3}₀) for the respective wavelength components by a focusing lens 40 having a prescribed focal length f. For simplicity's sake, the wavelength components are described as wavelengths λ₁, λ₂ and λ₃. However, the laser beam may be a laser beam having continuous wavelength components within the wavelength band (a laser beam having a continuous spectrum). In the case of using abeam source that outputs a laser beam having discrete wavelength components, each beam spot is formed at a focal position corresponding to each wavelength component. On the other hand in the case of using a beam source that outputs a laser beam having a continuous spectrum, beam spots are formed continuously and form a focusing line 3 in which respective focuses are arranged on an optical axis.

When laser processing using such a laser beam is applied to sapphire, a length of a modified layer in sapphire, which is the material to be processed, depends on a focusing line length of an optical energy density exceeding a damage threshold (Sa.ₜₕ) of sapphire. Therefore in order to control the length of the modified layer, the focusing line length needs to be controlled. For example, when a thickness of sapphire (crystal thickness) is large, it is desirable that a long modified layer can be formed by single irradiation. In order to form such along modified layer, it is required to control the magnitude of chromatic aberration in focusing lens 40 so as to correspond to the required length of the modified layer.

A method for controlling the magnitude of chromatic aberration includes a method described below. Specifically, the inventors focused attention on a wavefront shape of a laser beam having wavelengths that enters the focusing lens, and showed that a wavefront of the laser beam entering the focusing lens can be adjusted to be convex or concave for each wavelength toward the traveling direction of the laser beam, and found a method for controlling chromatic aberration in the focusing lens. Specifically, toward the traveling direction of a multi-wavelength laser beam, a wavefront of the laser beam having a long wavelength is adjusted to be convex and a wavefront of the laser beam having a short wavelength is adjusted to be concave, and thereby, a distribution range of focusing points of the laser beam (chromatic aberration) can be enlarged as compared with the case in which a wavefront of an all-wavelength laser beam emitted from the laser beam source is a planar wave. On the other hand, in the case where the wavefronts of the laser beam having the long wavelength and the laser beam having the short wavelength are adjusted to be concave and convex, respectively, the chromatic aberration can be suppressed as compared with the case in which the wavefront of the all-wavelength laser beam emitted from the laser beam source is a planar wave.

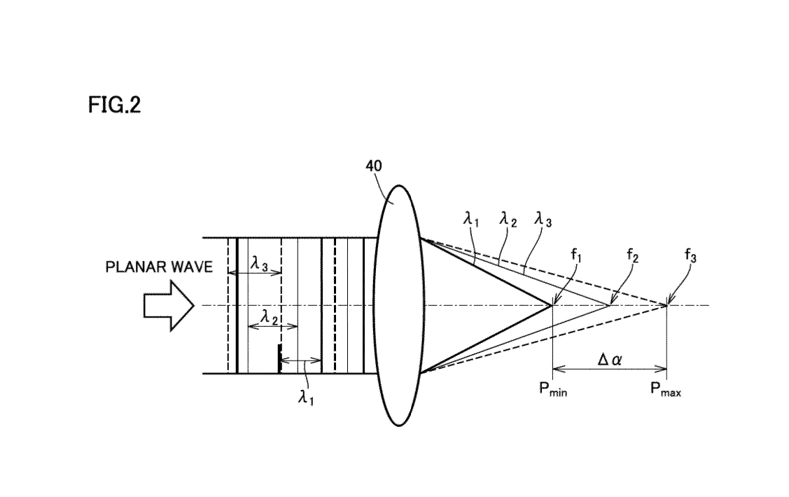

The inventors conducted the following study of the method for controlling the chromatic aberration in the focusing lens. Referring to FIG. 2, description will be given first to the case in which all wavelength components included in the laser beam are planar waves having planar incidence wavefronts. In FIG. 2, a relationship among wavelengths λ₁, λ₂ and λ₃ of the wavelength components included in the laser beam is λ₁<λ₂<λ₃. A focal position f₁ of the wavelength component having a relatively short wavelength, i.e., wavelength λ₁, is located on the focusing lens 40 side. On the other hand, a focal position f₃ of the wavelength component having a relatively long wavelength, i.e., wavelength λ₃, is located on the side distant from focusing lens 40. A focal position f₂ of the wavelength component having an intermediate value, i.e., wavelength λ₂, is located between focal position f₁ and focal position f₃. As described above, the focal positions of the short wavelength component and the long wavelength component are separated from each other, and the respective wavelength components are focused at different points (a point Pmin (nearest focal position) to a point Pmax (farthest focal position)) depending on the wavelengths, and chromatic aberration Δα occurs.

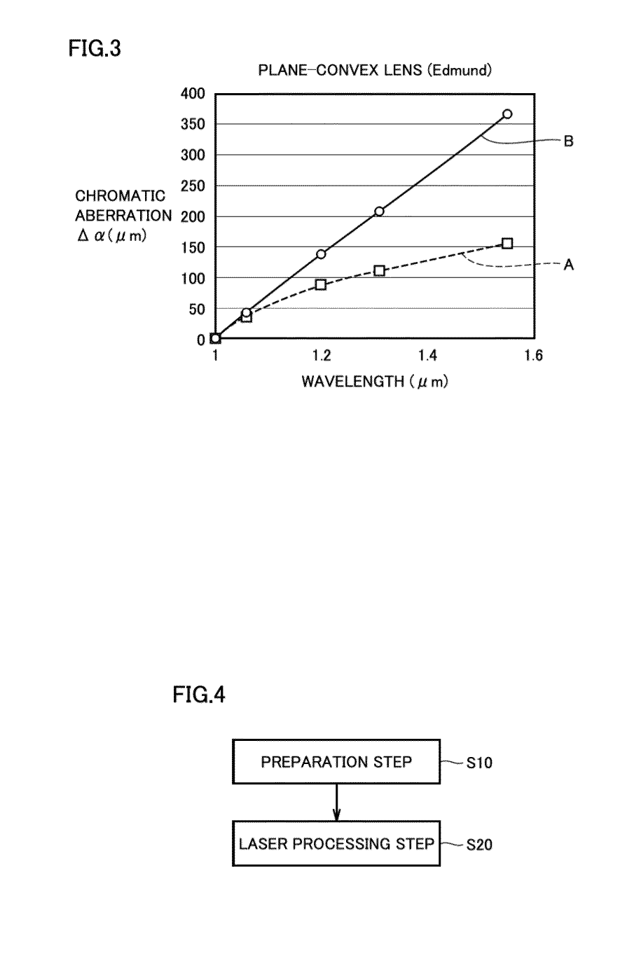

As described above, due to a difference among the wavelengths of the wavelength components included in the laser beam, chromatic aberration Δα occurs. A value of this chromatic aberration Δα is also affected by the property of the focusing lens. This will be described hereinafter with reference to FIG. 3.

FIG. 3 is a graph showing a relationship between the wavelength of the laser beam and the chromatic aberration with regard to the focusing lens, and the horizontal axis indicates the wavelength of the laser beam (unit: μm) and the vertical axis indicates chromatic aberration Δα (unit: μm). Wavelength bandwidths are set at 1 μm, 1.06 μm, 1.2 μm, 1.31 μm , and 1.55 μm.

A graph shown by a dotted line A in FIG. 3 indicates the case in which a planar wave having a planar wavefront shape enters a focusing lens having focal length f of 7.5 mm. A graph shown by a solid line B in FIG. 3 indicates the case in which a planar wave enters a focusing lens having focal length f of 27 mm. It is to be noted that FIG. 3 shows a calculation result when a plane-convex lens made of Edmund is used as the focusing lens. In FIG. 3, using a focal position of the laser beam having a wavelength of 1 μm as a reference point, a difference between the focusing point position of each wavelength and the aforementioned reference point (chromatic aberration Δα) is shown.

As can be seen from FIG. 3, chromatic aberration Δα can be increased in the case of using the focusing lens having focal length f of 27 mm. Therefore, as a method for increasing chromatic aberration Δα, use of a lens having long focal length f is conceivable.

However, in a laser processing apparatus used in the laser processing method, it is also conceivable that when the focusing lens is attached to a laser head or a processing stage, there are restrictions in some cases as to the size of the focusing lens due to the apparatus configuration around a position where the focusing lens is attached. In such a case, it is difficult to use a lens having unlimitedly long focal length f. In addition, the chromatic aberration in the case of the incident beam being a planar wave is uniquely determined by the wavelength band of the incident laser beam and a value of focal length f of the focusing lens, and thus, it was conventionally difficult to increase the chromatic aberration to be greater than the determined magnitude.

Furthermore, in the case of laser processing of materials to be processed having various thicknesses, it is preferable to change a length of the chromatic aberration of the laser beam (i.e., a length of the focusing area) in accordance with the thicknesses of the materials to be processed. However, in order to change the length of the chromatic aberration as described above, it is necessary to replace the focusing lens with a lens having desirable focal length f or to adjust the wavelength range of the laser beam entering the focusing lens. In addition, due to restrictions as to the lens property of the prepared focusing lens, there are limitations to tine adjustment of chromatic aberration Δα. Furthermore, in order to collimate the laser beam entering the focusing lens, with as little chromatic aberration as possible, it is necessary to use an expensive lens having less chromatic aberration, which also results in an increase in apparatus cost.

Another point to note is that when the focusing lens having the long focal length is used, a beam spot diameter through the focusing lens is enlarged and a power density is reduced, and thus, the power density may fall below the damage threshold of the material to be processed. Therefore, it is necessary to select the focusing lens in consideration of the damage threshold (power density subjected to damage) of the material to be processed.

As shown in FIGS. 4 to 6, the laser processing method according to the present invention completed to solve the aforementioned conventional problems is a laser processing method using a laser processing apparatus including a laser beam source 10 for outputting a laser beam including a plurality of wavelength components, a collimating lens 30 for receiving the laser beam emitted from laser beam source 10, a focusing lens 40 for receiving the laser beam collimated by collimating lens 30, a collimating lens position adjusting unit 50 for adjusting a position of collimating lens 30 with respect to laser beam source 10, and a focusing lens position adjusting unit for adjusting a position of focusing lens 40 with respect to collimating lens 30, the laser processing method including: a preparation step (S10) which is a step of preparing a material to be processed; and a laser processing step (S20) which is a step of irradiating the material to be processed with the laser beam focused by focusing lens 40 in laser beam processing apparatus 100.

In the preparation step shown in FIG. 4, the material to be processed is prepared and the material to he processed is arranged at a prescribed position (e.g., on a surface of a specimen table for holding the material to be processed) of the laser processing apparatus.

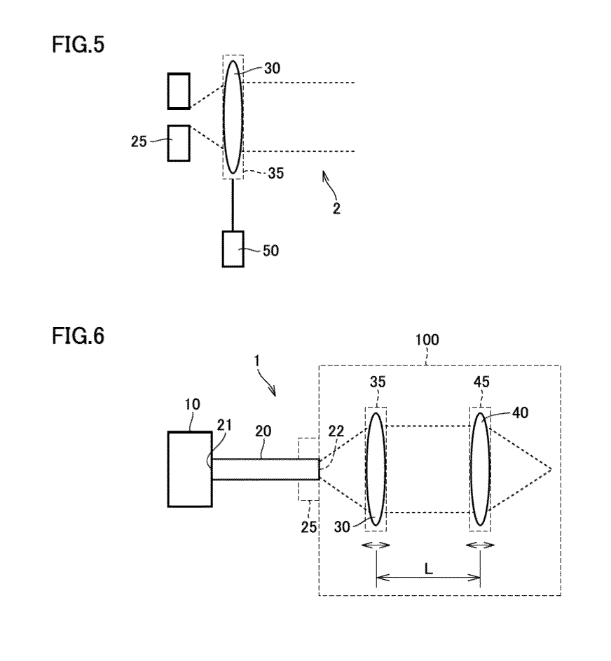

An example of an apparatus configuration of the laser processing apparatus used in the laser processing method according to the present invention will now be described with reference to FIGS. 5 and 6. The laser processing apparatus according to the present invention includes an optical system 1 shown in FIG. 6, the specimen table (not shown) for holding the material to be processed irradiated with the laser beam from optical system 1, moving means (not shown) for changing a relative position between the specimen table and optical system 1 to change an irradiation position of the laser beam with respect to the material to be processed held on the specimen table, and a control unit for controlling the moving means and optical system 1. FIG. 5 shows a collimating device 2 that forms the laser processing apparatus. Collimating device 2 is configured by a laser beam entering unit 25 for setting an emission position of the laser beam (e.g., an emission end face 22 of an optical fiber (an input port of a laser beam irradiation apparatus)), collimating lens 30, a collimating lens placement unit 35 for fixing collimating lens 30, and the position adjusting unit 50 (collimating lens position adjusting unit) for adjusting a position of collimating lens placement unit 35 to adjust an interval between laser beam emission end face 22 of laser beam entering unit 25 and the position of collimating lens 30. Position adjusting unit 50 may be placed to be capable of adjusting a position of laser beam entering unit 25.

FIG. 6 shows optical system 1 that forms the laser processing apparatus. Optical system 1 in FIG. 6 includes: laser beam source 10; an optical fiber 20 connected to laser beam source 10, for guiding the laser beam outputted from laser beam source 10; laser beam entering unit 25; collimating lens 30; collimating lens placement unit 35 for fixing collimating lens 30; focusing lens 40; a focusing lens placement unit 45 for fixing focusing lens 40; and a position adjusting unit (not shown) for adjusting a position of focusing lens placement unit 45. Among these, laser beam entering unit 25, collimating lens 30, collimating lens placement unit 35, and the not-shown position adjusting unit function as collimating device 2, as shown in FIG. 5. In collimating device 2, emission end face 22 of optical fiber 20 is fixed by laser beam entering unit 25. In order to avoid damage to the end face of optical fiber 20, emission end face 22 of optical fiber 20 may have, at an end thereof, an end cap structure of a coreless fiber for reducing the power density of the laser beam guided through optical fiber 20. in addition, a lens having chromatic aberration may be used as collimating lens 30, and a lens having chromatic aberration or a lens having no (or extremely little) chromatic aberration may be used as focusing lens 40.

Emission end face 22 of optical fiber 20 is fixed by laser beam entering unit 25. This emission end face 22 is the input port for taking in the laser beam from laser beam source 10. Collimating lens 30 is fixed by collimating lens placement unit 35 and collimates the laser beam from emission end face 22 serving as the input port. By position adjusting unit 50, a relative position between collimating lens placement unit 35 and laser beam entering unit 25 may be variable in units of μm. Focusing lens 40 is fixed by focusing lens placement unit 45 and focuses the laser beam from collimating lens 30. A distance L between focusing lens placement unit 45 and collimating lens placement unit 35 may be variable, and this distance L (a relative position between focusing lens placement unit 45 and collimating lens placement unit 35) may be changeable in units of 10 mm.

A reference numeral 100 in FIG. 6 represents an emission optical system including aforementioned collimating lens 30, collimating lens placement unit 35, position adjusting unit 50 that allows a change in units of μm, focusing lens 40, and focusing lens placement unit 45. The emission optical system is configured such that distance L between focusing lens placement unit 45 and collimating lens placement unit 35 is variable in units of 10 mm, the laser beam having a wavelength range of 100 nm or more (e.g., 1 μm to 1.3 μm) is emitted from emission end face 22, a wavefront of each wavelength component is constant at emission end face 22, and the interval between emission end face 22 and collimating lens 30 is adjusted such that any one of the wavelength components included in the laser beam is a planar wave at a placement position of collimating lens 30.

Using the aforementioned laser processing apparatus, the laser processing step (S20) is performed subsequently to the preparation step (S10) shown in FIG. 4. In the laser processing step (S20), the material to he processed is irradiated with the laser beam as described above, and thereby, a modified layer is formed in the material to be processed. At this time, the positions of collimating lens 30 and focusing lens 40 are adjusted by collimating lens position adjusting unit 50 and the focusing lens position adjusting unit, and a wavefront shape of each wavelength of the laser beam received by focusing lens 40 is adjusted. As a result, the size of a focusing area constituted by a plurality of focuses corresponding to a plurality of wavelength components of the laser beam focused by focusing lens 40 is adjusted. It is preferable to adjust the size of the focusing area in accordance with the size of the material to be processed (e.g., the thickness of the material to be processed in a direction along the optical axis direction of the laser beam).

With such a configuration, by adjusting the wavefront shape of the laser beam received by focusing lens 40, the chromatic aberration in the focusing lens can be increased or decreased as compared with the case in which the all-wavelength laser beam received by focusing lens 40 is a planar wave as described below. As a result, the size of the focusing area of the laser beam can be adjusted over a wider range, as compared with the case in which the size of the focusing area is adjusted based only on the property of focusing lens 40 and the wavelength of the laser beam. In addition, as described above, the size of the focusing area can be adjusted by adjusting the positions of collimating lens 30 and focusing lens 40. Therefore, replacement of the focusing lens itself, change of the wavelength of the laser beam, and the like are not required, and the size of the focusing area can be easily adjusted. Thus, the length of the focusing area can be easily adjusted in accordance with the thickness of the processed area of the material to be processed (the thickness in the direction along the optical axis direction).

Description will now be given to a mechanism for adjusting the wavefront shape of each wavelength of the laser beam received by focusing lens 40, thereby adjusting the size of the focusing area of the laser beam focused by focusing lens 40.

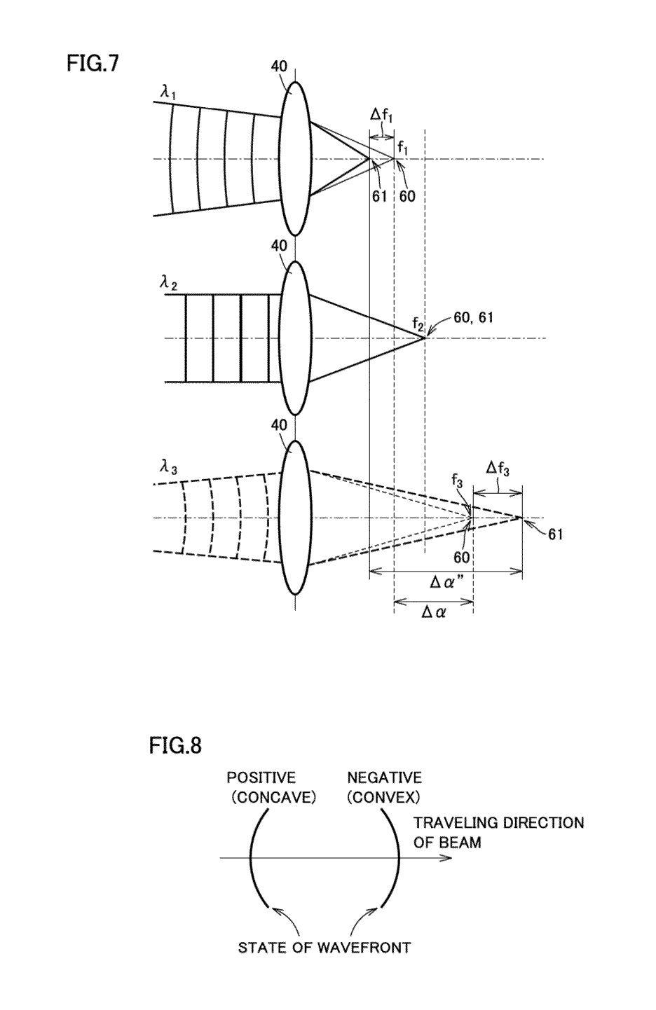

As a method for further increasing the chromatic aberration in focusing lens 40, the inventors focused attention on the wavefront of the incident beam entering focusing lens 40. The method for increasing the chromatic aberration will be schematically described with reference to FIG. 7. FIG. 7 is a schematic view showing the case in which laser beams having different wavefront shapes enter focusing lens 40, and FIG. 8 is a schematic view for describing a method for drawing the wavefront shape. Adjustment of the aforementioned wavefront shapes of the laser beams entering focusing lens 40 can be made by position adjusting unit 50 shown in FIG. 5 or by adjusting the position of focusing lens placement unit 45 with respect to collimating lens 30, for example.

The relationship among wavelengths λ₁, λ₂ and λ₃ shown in FIG. 7 is λ₁<λ₂<λ₃. The laser beam component of wavelength λ₁ has a positive curvature radius shown in FIG. 8 when entering focusing lens 40. “Positive” herein refers to the case in which the wavefront shape of the laser beam is concave toward the traveling direction of the laser beam. The laser beam component of wavelength λ₂ is a planar wave when entering focusing lens 40. The laser beam component of wavelength λ₃ has a negative curvature radius when entering focusing lens 40. “Negative” herein refers to the case in which the wavefront shape of the laser beam is convex toward the traveling direction of the laser beam. Thus, when the wavefront shape of the laser beam entering focusing lens 40 is controlled to have the wavelength component of aforementioned wavelength λ₁, λ₂ or λ₃, the focal position of each wavelength is shifted to a focal position 61 of each wavelength from a focal position 60 of each wavelength in the case of planar wave incidence, and the chromatic aberration increases. In other words, when the wavefront shape of the laser beam entering focusing lens 40 is positive, the focal length is shorter than the focal length when the laser beam is a planar wave. On the other hand, when the wavefront shape of the laser beam entering focusing lens 40 is negative, the focal length is longer than the local length when the laser beam is a planar wave. As a result, when the wavefronts of wavelengths λ₁ and λ₃ are defined as being positive and negative, respectively, as shown in FIG. 7, the chromatic aberration is increased as compared with chromatic aberration Δα of the laser beam in the case of planar wave incidence of each wavelength. In FIG. 7, the chromatic aberration in this case is expressed as Δα″. f₁, f₂ and f₃ in FIG. 7 are the same focal positions as f₁, f₂ and f₃ in FIG. 2, and represent the case of planar wave incidence of each wavelength. Δf₁ and Δf₃ represent an amount of displacement of the focal position with respect to reference positions f₁ and f₃ when the wavefronts of wavelengths λ₁ and λ₃ are controlled to be positive and negative, respectively. These represent the degree of increase in chromatic aberration with respect to focal positions f₁ and f₃.

In order to increase the chromatic aberration in the focusing lens as described above, the wavefront of each wavelength component included in the laser beam entering the focusing lens needs to have a desirable shape (a wavefront shape having a desirable curvature radius). Thus, according to the inventor's research, the wavelength component of the laser beam can be formed into a non-planar wave by using the following method.

Specifically, first, in FIGS. 5 and 6, the position of collimating lens 30 or focusing lens 40 is adjusted, and thereby, the laser beam emitted from the fiber end and entering focusing lens 40 through collimating lens 30 is collimated. In this case, by using position adjusting unit 50 and the like, the placement position of collimating lens 30 or the placement position of focusing lens 40 is adjusted on the optical axis.

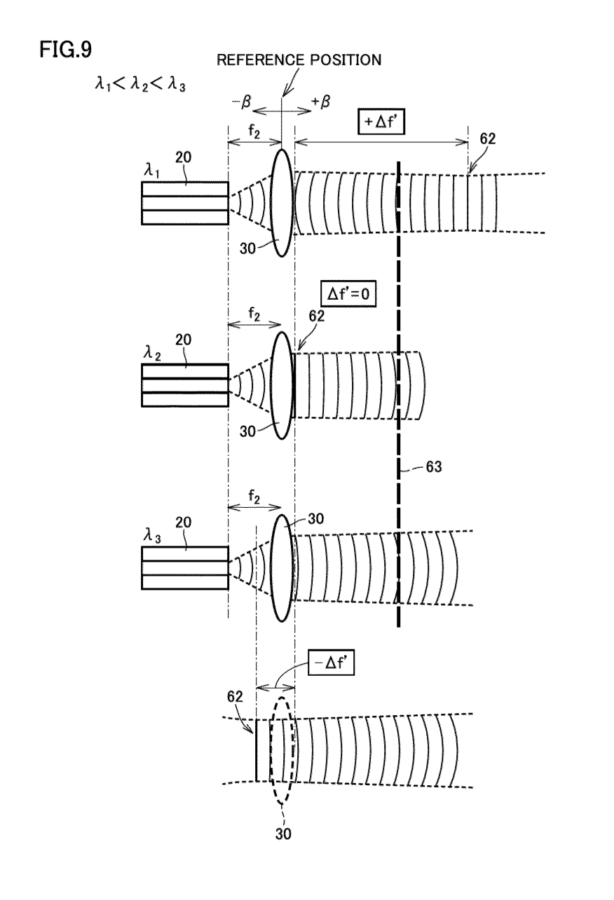

Then, as shown in FIG. 9, collimating lens 30 is placed at a position where, when the laser beam component having center wavelength λ₂ of the laser beam outputted from laser beam source 10 is emitted from the collimating lens, the laser beam component is focused at emission end face 22 of optical fiber 20 (a position where a distance from emission end face 22 to collimating lens 30 is focal length f₂ of the laser beam component having the aforementioned center wavelength). Similarly to FIG. 7, the relationship among wavelengths λ₁, λ₂ and λ₃ in FIG. 9 is λ₁<λ₂<λ₃.

A beam propagation state of the laser beam after collimating lens 30 is calculated with consideration given to a mode field diameter (MFD) of each wavelength propagating through optical fiber 20 and a spread angle of each laser beam component from emission end face 22 of optical fiber 20, when collimating lens 30 is placed at the position where the distance from emission end face 22 to collimating lens 30 is aforementioned focal length f₂ as described above. As a result, a beam waist position 62 of the wavelength component having wavelength λ₁ appears at a position distant from collimating lens 30, as compared with beam waist positions 62 of the wavelength components having wavelengths λ₂ and λ₃ (a position distant by +Δf (Δf>0) from beam waist position 62 of λ₂ toward the emission direction of the laser beam). On the other hand, beam waist position 62 of the wavelength component having wavelength λ₂ is present near the placement position of collimating lens 30 (Δf=0) because collimating lens 30 is placed at the position of focal length f₂ as described above. In addition., as shown in the lowermost part in FIG. 9, beam waist position 62 of the wavelength component having wavelength λ₃ is present on the optical fiber 20 side with respect to collimating lens 30 (at a position distant by −Δf (Δf<0) from collimating lens 30 toward the optical fiber 20 side). Actually, the beam waist is not present in this case, and thus, beam waist position 62 shown in the lowermost part in FIG. 9 is imaginary.

When focusing lens 40 is placed at a position shown by a line 63 in FIG. 9, the wavefront shape of the wavelength component having wavelength λ₁, of the laser beam entering focusing lens 40, is positive, the wavefront shape of the wavelength component having wavelength λ₂ is negative, and the wavefront shape of the wavelength component having wavelength λ₃ is negative. This tendency of the change in wavefront shape of each wavelength component is consistent with the tendency in the case of increasing the chromatic aberration as shown in FIGS. 7 and 8. Strictly speaking, the placement position of collimating lens 30 where the chromatic aberration is maximized differs depending on a difference in type, material and manufacturer of collimating lens 30. However, this can be dealt with by using a device for adjusting the distance from emission end face 22 of optical fiber 20 to collimating lens 30 (the placement position of collimating lens 30) with precision to approximately 10 μm.

As described above, without taking measures such as change of the material or type of focusing lens 40, the chromatic aberration can be increased by adjusting the positions of collimating lens 30 and focusing lens 40.

This method for increasing the chromatic aberration is realized by adjusting placement distance L between the collimating lens and the focusing lens as well as an interval β between the fiber end and collimating lens 30. An example of calculation will be described below. As a reference position 0 of β used in the present calculation, a position for a focal length of wavelength 1.31 μm in the case of using 69587 (focal length f=7.5 mm) manufactured by Edmund as collimating lens 30 is set. With respect to this position, a shift to the focusing lens side is defined as +β and a shift to the fiber end face side is defined as −β.

In the aforementioned laser processing method according to the present invention, in the laser processing step (S20) which is the step of emitting the laser beam, when a reference position is a focal length of a center wavelength component of the aforementioned collimating lens among the wavelength components included in the laser beam emitted from laser beam source 10, the aforementioned collimating lens is adjusted to be arranged on the focusing lens side with respect to the reference position within a range of 100 μm to 850 μm. The interval between the aforementioned collimating lens and the aforementioned focusing lens may be adjusted within a range of 10 mm to 500 mm.

Even if both the short-wavelength laser beam and the center-wavelength laser beam emitted from collimating lens 30 have such a component (positive component) that the wavefront shape is concave toward the traveling direction of the laser beam, the size of the focusing area can be effectively increased (lengthened in the optical axis direction) similarly to FIGS. 7 and 8, when the curvature radius of the wavefront of the short-wavelength laser beam is smaller than that of the center-wavelength laser beam.

In the aforementioned laser processing method, the laser beam may have a continuous spectrum with a prescribed wavelength width. In this case, the focuses of the laser beam focused by focusing lens 40 form a collection of continuous focusing points (focusing line 3), and thus, this focusing line 3 can form a linear modified area in the material to be processed. Therefore, by moving the material to be processed with respect to the focusing area of the laser beam. (e.g., moving the material to be processed in the direction perpendicular to the optical axis direction of the laser beam), a modified area having an arbitrary planar shape can be formed in the material to be processed.

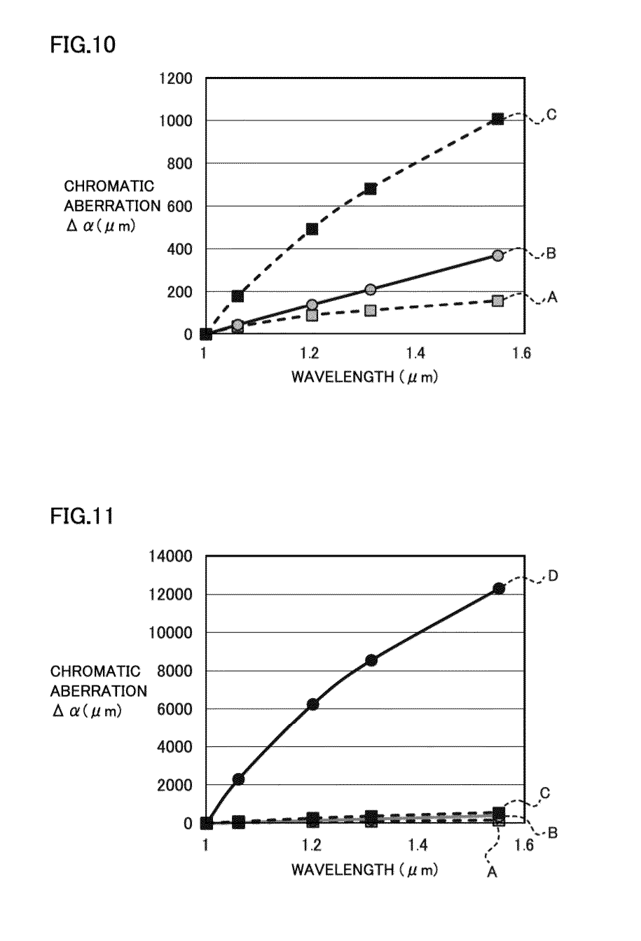

Now, a relationship between the wavelength of the laser beam and the chromatic aberration in the plane-convex lens (focal length f=7.5 mm) having the chromatic aberration increased according to the laser processing method of the present invention is obtained by calculation. An example of the result is shown in FIG. 10. The vertical axis and the horizontal axis in FIG. 10 are the same as those in the graph shown in FIG. 3. Similarly to FIG. 3, wavelength bandwidths are set at 1 μm, 1.06 μm, 1.2 μm, 1.31 μm, and 1.55 μm.

FIG. 10 also shows the result of calculation in FIG. 3 (a curved line A and a curved line B in the graph) for the purpose of reference. Curved lines A and B in the graph of FIG. 10 correspond to dotted line A and solid line B in FIG. 3, respectively. A curved line C in the graph of FIG. 10 represents the result of calculation in the case of increasing the chromatic aberration according to the present invention. In curved line C, the lens having focal length f of 7.5 mm is used similarly to curved line A, and further, distance L between the collimating lens and the focusing lens (a distance between collimating lens 30 and line 63 in FIG. 9) is 60 mm and interval β from the fiber end to collimating lens 30 is 850 μm. As shown by curved line A in FIG. 10, when the incident beam is a planar wave (wavelength band: 1.0 μm to 1.55 μm) and the focusing lens having focal length f of 7.5 mm is used, chromatic aberration Δα is approximately 150 μm. On the other hand, as shown by curved line C, use of the method for increasing the chromatic aberration according to the present invention results in an about sixfold increase in chromatic aberration Δα.

A relationship between the wavelength of the laser beam and the chromatic aberration in the plane-convex lens (focal length f=27 mm) having the chromatic aberration increased according to the laser processing method of the present invention is also obtained by calculation. An example of the result is shown in FIG. 11. The vertical axis and the horizontal axis in FIG. 11 are the same as those in the graph shown in FIG. 10. Similarly to FIGS. 3 and 10, wavelength bandwidths are set at 1 μm, 1.06 μm, 1.2 μm, 1.31 μm and 1.55 μm.

FIG. 11 also shows the result of calculation in FIG. 10 (a curved line A to a curved line C in the graph) for the purpose of reference. In a curved line D, the lens having focal length f of 27 mm is used similarly to curved line B, and distance L between the collimating lens and the focusing lens (the distance between collimating lens 30 and line 63 in FIG. 9) is 120 mm similarly to curved line C, and interval β from the fiber end to collimating lens 30 is 500 μm. Based on the foregoing, curved line A and curved line C in FIGS. 10 and 11 represent the result in the case of focal length f=7.5 mm, and curved line B and curved line D in FIGS. 10 and 11 represent the result in the case of focal length f=27 mm.

As can be seen from FIG. 11, when the focusing lens having focal length f of 27 mm is used, chromatic aberration Δα in the case of applying the method for increasing the chromatic aberration according to the present invention is more than thirty-three times greater than chromatic aberration Δα in the case of not applying the method for increasing the chromatic aberration (data shown by curved line B), and the chromatic aberration is significantly increased.

Based on the aforementioned results, the magnitude of the chromatic aberration in the focusing lens having the long focal length can be made greater than that in the focusing lens having the short focal length. However, when the damage threshold of the material to be processed is taken into consideration, the focused power density is important. In other words, when the focusing lens having the long focal length is used, the beam spot diameter after the focusing lens tends to be enlarged and may become equal to or smaller than the damage threshold in some cases. Therefore, when the method for increasing the chromatic aberration is applied, it is necessary to focus attention on the beam spot diameter with consideration given to the magnitude of the chromatic aberration and the damage threshold of the material to be processed.

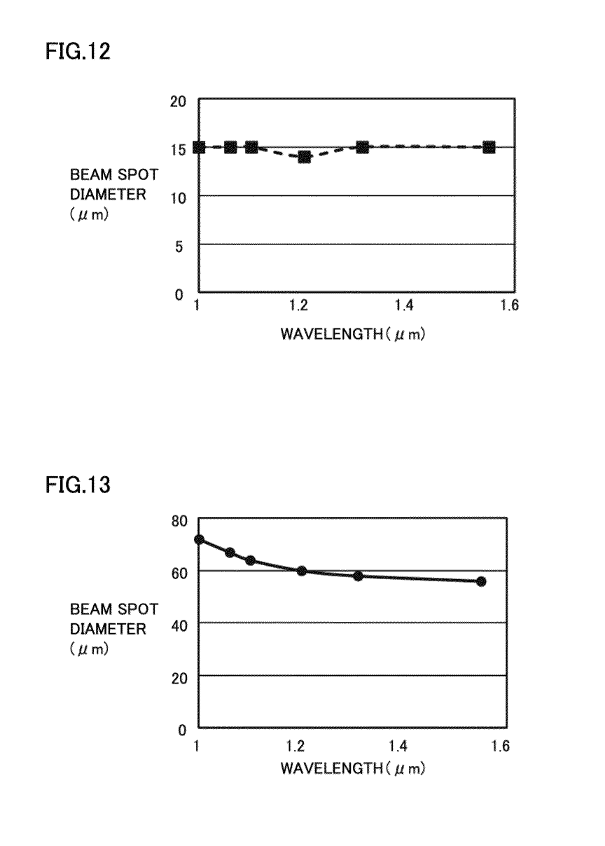

FIG. 12 shows a calculation result of the beam spot diameter with respect to each wavelength in the case of FIG. 10(C) in which focal length f is 7.5 mm, and FIG. 13 shows a calculation result of the beam spot diameter with respect to each wavelength in the case of FIG. 11(D) in which focal length f is 27 mm. Wavelength bandwidths are set at 1 μm, 1.06 μm, 1.1 μm, 1.2 μm, 1.31 μm, and 1.55 μm.

As can be seen from FIG. 12, in the case of focal length f=7.5 mm, the beam spot diameter of each wavelength is approximately 15 μm. On the other hand, in the case of focal length f=27 mm shown in FIG. 13, the beam spot diameter is approximately 60 μm to 70 μm, which is 4.6 times larger than the beam spot diameter in the case of f=7.5 mm. In other words, in terms of the power density, the power density in the case of 27 mm decreases approximately twentyfold as compared with the power density in the case of f=7.5 mm, For example, in order to form the modified layer in the sapphire substrate by using a pulsed beam source having an average power of approximately 20 W, a pulse width of 100 ps to 1000 ps, a peak value of 80 kW, and a pulse repetition rate of 100 kHz to 1000 kHz, the beam spot diameter is approximately on the order of 13 μm. In other words, when the material to be processed is sapphire, formation of the modified layer is difficult under the aforementioned setting conditions for increasing the chromatic aberration as shown in FIGS. 10 and 11.

Thus, attention is focused on the beam spot diameter after the focusing lens and calculation is performed by using, as parameters, interval β between fiber end face 22 and collimating lens 30 as well as interval L between collimating lens 30 and focusing lens 40, which are the setting conditions for the method for suppressing the chromatic aberration. Wavelength bandwidths are set at 1 μm, 1.06 μm, 1.1 μm, 1.2 μm, 1.31 μm, and 1.55 μm.

FIG. 15 shows a calculation result of a maximum value of the beam spot diameter with respect to interval L. FIG. 15 shows the calculation result when each of the collimating lens and the focusing lens has focal length f of 7.5 mm and the values of β are −260 μm, +20 μm, +180 μm, +260 μm, +360 μm, +500 μm, and +850 μm. The maximum value of the beam spot diameter refers to the largest beam spot diameter among the beam spot diameters for the respective wavelengths. As the value of β becomes larger, the range of interval L where calculation is performed becomes smaller. This is because the condition for allowing the focusing lens to have an effective opening size or smaller is set.

Referring to FIG. 15, the maximum value of the beam spot diameter tends to increase as the value of β increases. In addition, the maximum value of the beam spot diameter appears when interval L is between approximately 50 mm and approximately 200 mm. Attention is focused on, for example, the beam spot diameter of 13 μm for forming the modified area in sapphire described above. The value of β and interval L at which the beam spot diameter becomes 13 μm are as follows: (1) β=180 μm and L=190 mm, (2) β=260 μm and L=135 mm, (3) β=360 μm and L=110 mm, (4) β=500 μm and L=85 mm, and (5) β=850 μm and L=55 mm. In other words, this condition is an upper limit for forming the modified area in sapphire.

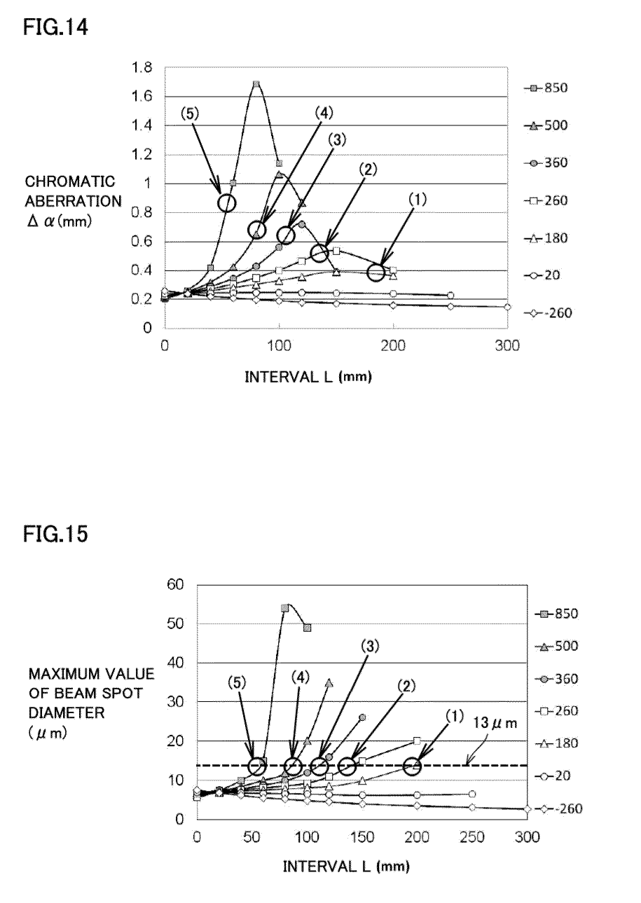

FIG. 14 shows a calculation result chromatic aberration Δα with respect to interval L. The parameters are the same as those in FIG. 15. The conditions (1) to (5) obtained in FIG. 15 under which the beam spot diameter becomes 13 μm are plotted in FIG. 14. A value chromatic aberration Δα in each condition is as follows: (1) 370 μm, (2) 380 μm, (3) 660 μm, (4) 720 μm, and (5) 840 μm. This shows that chromatic aberration Δα of 840 μm at maximum is formed.

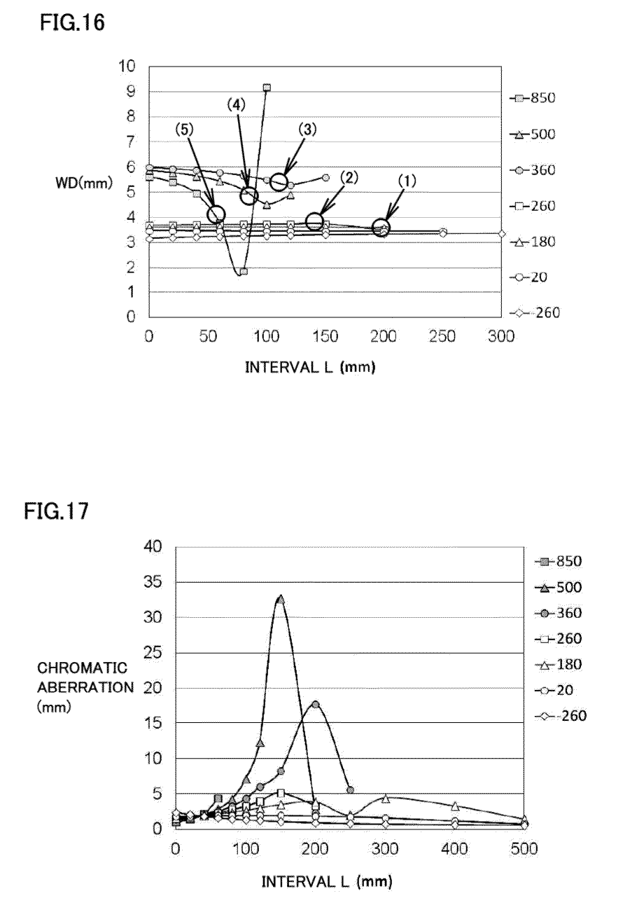

FIG. 16 shows a working distance (WD) with respect to interval L. Similarly to FIG. 14, the conditions (1) to (5) under which the beam spot diameter becomes 13 μm are also plotted in FIG. 16. WD in each condition is as follows: (1) WD=3.6 mm, (2) WD=3.6 mm, (3) WD=5.4 mm, (4) WD=5.0 mm, and (5) WD=4.2 mm. Under either condition WD is within a range where laser processing is possible. However, particularly under the condition (3), WD is 5.4 mm, which is the largest, and this shows that the range of application a laser processing is extended.

Based on the foregoing, chromatic aberration Δα can be controlled by using the two parameters, i.e., interval L and the value of β, with respect to the size of the beam spot diameter. In addition, when the aforementioned laser beam source is used, the modified layer of 840 μm at maximum can be formed in sapphire.

When the material to be processed is a material having a damage threshold smaller than that of sapphire, it is not necessary to stick to the beam spot diameter of 13 μm, and the beam spot diameter may be equal to or larger than several tens of micrometers as long as the power density equal to or higher than a prescribed damage threshold corresponding to each material can be produced. In addition, by applying the high-peak and large-output laser of the laser beam source, the range of limitation of the beam spot diameter can be extended.

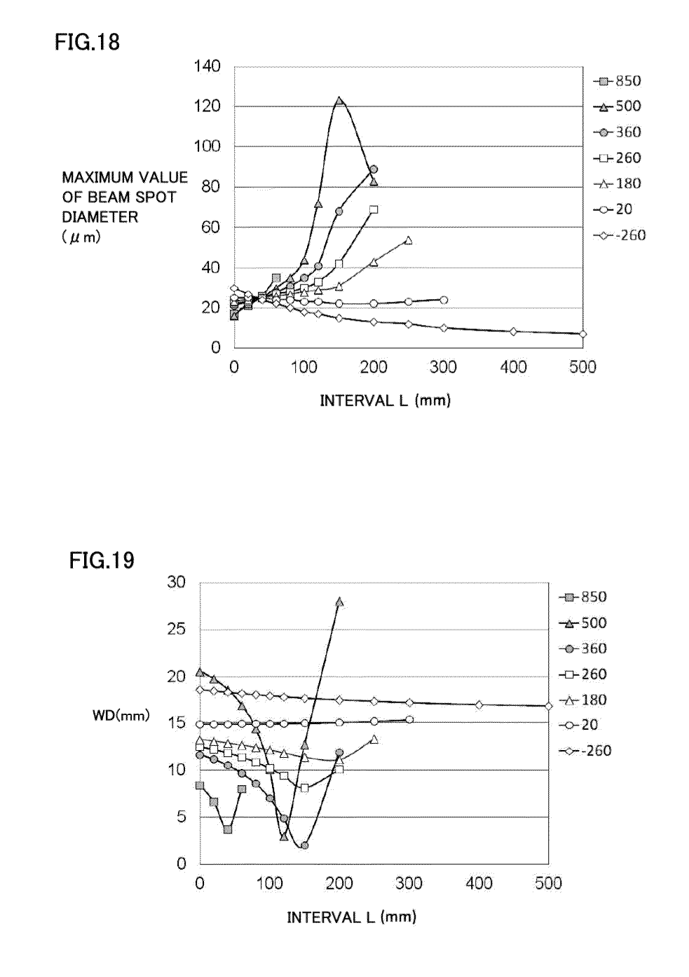

FIGS. 17, 18 and 19 show calculation results of Δα, the maximum value of the beam spot diameter, and WD with respect to interval L when collimating lens 30 has focal length f of 7.5 mm and focusing lens 40 has focal length f of 27 mm. The conditions of the wavelength range, the value of β and interval L are the same as the aforementioned conditions. As can be seen from FIGS. 17 and 18, when the value of β is 500 μm and the value of L is about 110 mm, for example, the maximum value of the beam spot diameter is approximately 70 μm. At this time, chromatic aberration Δα can be increased to approximately 12 mm.

As described above, according to the present invention, the value of chromatic aberration Δα can be arbitrarily adjusted, and thus, chromatic aberration Δα can be increased and the length or the focusing line can be increased. However, the increase in chromatic aberration Δα means a reduction in beam power density of the laser beam emitted onto the material to be processed. Therefore, it is preferable to adjust the beam intensity such that the beam power density of the formed focusing line becomes equal to or higher than the damage threshold of the material to be processed (e.g., sapphire and the like).

It should be understood that the embodiment disclosed herein is illustrative and not limitative in any respect. The scope of the present invention is defined by the terms of the claims, rather than the description above, and is intended to include any modifications within the scope and meaning equivalent to the terms of the claims.

### INDUSTRIAL APPLICABILITY

The present invention is especially advantageously applied to a laser processing method in which a laser beam including a plurality of wavelength components is focused to form a focusing area by using chromatic aberration.

### REFERENCE SIGNS LIST

1 optical system; 2 collimating device; 3 focusing line; 10 laser beam source; 20 optical fiber; 22 emission end face; 25 laser beam entering unit; 30 collimating lens; 35 collimating lens placement unit; 40 focusing lens; 45 focusing lens placement unit; 50 position adjusting unit; 60, 61, f₁, f₂, f₃ focal position; 62 beam waist position; 63 line.

1. A laser processing method using a laser processing apparatus comprising a laser beam source for outputting a laser beam including a plurality of wavelength components, a collimating lens for receiving said laser beam emitted from said laser beam source, a focusing lens for receiving said laser beam collimated by said collimating lens, a collimating lens position adjusting unit for adjusting a position of said collimating lens with respect to said laser beam source, and a focusing lens position adjusting unit for adjusting a position of said focusing lens with respect to said collimating lens, the laser processing method comprising the steps of:
preparing a material to be processed; and
irradiating said material to be processed with said laser beam focused by said focusing lens in said laser processing apparatus, wherein
in the step of irradiating said material to be processed with said laser beam, positions of said collimating lens and said focusing lens are adjusted by said collimating lens position adjusting unit and said focusing lens position adjusting unit, and a wavefront shape of said laser beam received by said focusing lens is adjusted, thereby adjusting a size of a focusing area constituted by a plurality of focuses corresponding to said plurality of wavelength components of said laser beam focused by said focusing lens.

2. The laser processing method according to claim 1, wherein
said laser beam has a continuous spectrum with a prescribed wavelength width and has a wavelength range of 1 to 1.3 μm.

3. The laser processing method according to claim 1, wherein
in the step of irradiating said material to be processed with said laser beam, when a reference position is a focal length of a center wavelength component of said collimating lens among the wavelength components included in said laser beam emitted from said laser beam source, said collimating lens is adjusted to be located on the focusing lens side with respect to said reference position within a range of 100 μm to 850 μm, and an interval between said collimating lens and said focusing lens is adjusted within a range of 10 mm to 500 mm.

4. A laser beam irradiation apparatus that irradiates a material to be processed with a laser beam having a continuous spectrum with a prescribed wavelength width and including wavelength components within a wavelength range of 1 to 1.3 μm, the laser beam irradiation apparatus comprising:
an input port for taking in said laser beam from a laser beam source;
a collimating lens for collimating said laser beam from said input port; and
a focusing lens for focusing said laser beam from said collimating lens, wherein
said collimating lens is placed in a collimating lens placement unit and a placement position of said collimating lens with respect to said input port is adjusted by a collimating lens position adjusting unit,
a wavefront of each wavelength component of said laser beam is set to be constant at said input port, and
when a reference position is a focal length of a center wavelength component of said collimating lens, an interval between said input port and said collimating lens is adjusted such that said collimating lens is located on the focusing lens side with respect to said reference position within a range of 100 μm to 850 μm, and an interval between said collimating lens and said focusing lens is adjusted within a range of 10 mm to 500 mm.
